(19) United States
(12) Patent Application Publication
(10) Pub. No.: US 2016/0238003 A1
(43) Pub. Date: Aug. 18, 2016

(54) VARIABLE CAPACITY-TYPE GEAR PUMP DESIGNING METHOD, DESIGN SUPPORT PROGRAM FOR THE PUMP, DESIGN SUPPORT DEVICE FOR THE PUMP, AND VARIABLE CAPACITY-TYPE GEAR PUMP

(71) Applicant: YAMADA MANUFACTURING CO., LTD., Kiryu-shi (JP)

(72) Inventors: Masato Izutsu, Kiryu-shi (JP); Takatoshi Watanabe, Kiryu-shi (JP); Junichi Miyajima, Kiryu-shi (JP); Masaki Ogawara, Kiryu-shi (JP)

(21) Appl. No.: 15/002,093

(22) Filed: Jan. 20, 2016

(30) Foreign Application Priority Data
Feb. 13, 2015 (JP) 2015-026994

(51) Int. Cl. F04C 14/20; G06F 17/50; G06F 17/11; F04C 2/10

(52) U.S. Cl. CPC F04C 14/20; F04C 2/102; G06F 17/5086; G06F 17/11; F04C 2210/206; F04C 2240/20; F04C 2240/30

(57) ABSTRACT

A numerical value calculation model of a variable capacity-type gear pump is constructed on a computer (step 1); one or two or more temporary levers are provided on an outer ring and it is assumed that contact points of a compression spring are located at the temporary levers (step 2); a movement rule of the outer ring is defined (steps 3, 4, and 5); the outer ring is moved based on the movement rule to obtain a set of positional coordinate values of the contact points (steps 6, 7, 8, and 9); based on a statistical amount obtained by statistical processing on the set of coordinate values (step 10), appropriateness of the position of the temporary lever is determined (steps 11, 12, and 13).

### BACKGROUND OF THE INVENTION

1. Field of the Invention

The present invention relates to a variable-capacity type internal gear pump designing method, a design support program for the pump, a design support device for the pump, and a variable capacity-type gear pump.

2. Description of the Related Art

A variable-capacity type internal gear pump is used for supplying lubricating oil to an engine, a transmission, or the like of a vehicle. This pump supplies oil from a suction port to a discharge port by expansion and contraction of an engagement space formed by outer teeth of an inner rotor that rotates inside a pump housing and inner teeth of an outer rotor, engaging with the outer teeth with a certain eccentricity. The amount of supplied oil can be adjusted by moving the position of the outer rotor to change an eccentric direction.

The inner rotor has a rotation shaft fixed to the pump housing and rotates about the rotation shaft. On the other hand, the outer rotor is a disc that is rotatably held in the outer ring and the inner rotor is accommodated in inner teeth thereof. The position of the outer ring is adjusted so that the center of rotation of the outer rotor maintains a certain eccentricity e from the rotation shaft of the inner rotor. The outer ring performs a combination of a translational movement and a rotational movement under the above-described restrictions. This movement is automatically adjusted by the balance between compression spring force applied to a lever provided in the outer ring and hydraulic force applied through a flow path or the like. For example, the above-described variable capacity-type gear pump is disclosed in WO2010/013625.

### SUMMARY OF THE INVENTION

However, the lever may not move linearly depending on a contact position at which the lever makes contact with an end of the compression spring. Due to this, there is a problem that the repulsive force of the compression spring is not efficiently transmitted to the lever and the amount of oil as designed is not supplied. This problem occurs depending on the suitability of the position of the lever provided in the outer ring and the direction of the compression spring.

Therefore, an object of the present invention is to provide a variable capacity-type gear pump designing method of numerically calculating the movement of a contact point of a compression spring making contact with a lever provided in an outer ring and outputting a suitable position of the lever and a suitable direction of the compression spring based on the calculation result, a design support program, and a design support device.

The object of the present invention is achieved by a variable capacity-type gear pump designing method including: constructing a numerical value calculation model on a memory of a computer, the model calculating an operation of a variable capacity-type gear pump including an inner rotor, an outer rotor, an outer ring that rotatably accommodates and holds the outer rotor, and a compression spring that controls movement of the outer ring; providing one or two or more temporary levers on the outer ring in the numerical value calculation model and assuming that contact points of the compression spring are located on the temporary levers; defining a movement rule of allowing the outer ring to perform translational movement, rotational movement, or a combination of the translational movement and the rotational movement and storing the movement rule on the memory of the computer; moving the outer ring based on the movement rule by calculation of the computer and calculating positional coordinate values of the contact points over the moving range to obtain a set of coordinate values; and determining appropriateness of the position of the temporary lever based on a statistical amount obtained by statistical processing on the set of coordinate values.

The variable capacity-type gear pump designing method of the present invention has an effect that the moving trajectory of a contact point of a spring on the outer circumference of the outer ring or the temporary lever when changing the direction of the eccentric axial line is calculated, and the contact point of the spring on the outer circumference of the outer ring or the temporary lever at which the moving trajectory forms an approximately straight line can be found.

When an actual lever is provided at the position of the outer circumference of the outer ring at which the moving trajectory forms an approximately straight line and the compression spring is disposed on the trajectory that forms the approximately straight line, the repulsive force of the compression spring can be efficiently transmitted to the actual lever and the amount of supplied oil as designed can be realized.

### BRIEF DESCRIPTION OF THE DRAWINGS

FIG. 1 is a diagram illustrating an example of a flowchart of a variable capacity-type gear pump designing method of the present invention;

FIG. 2 is a diagram illustrating an example of setting the coordinate system of an outer ring according to the variable capacity-type gear pump designing method of the present invention;

FIG. 3 illustrates an example of a table of the trajectories of an assumed contact point of a spring according to the variable capacity-type gear pump designing method of the present invention;

FIG. 4A is a diagram illustrating a specific example of trajectories according to the variable capacity-type gear pump designing method of the present invention and FIG. 4B is a diagram illustrating a profile of a linearity index of the square of a Poisson's correlation coefficient according to another outer ring movement rule;

FIGS. 5A to 5C are diagrams illustrating an example of an outer ring movement rule according to the variable capacity-type gear pump designing method of the present invention;

FIG. 6A is a simplified diagram of a main component of a variable capacity-type gear pump according to the present invention, in which an eccentric axial line La is at an initial position, and FIG. 6B is a diagram in which the eccentric axial line La is at the position of 90 degrees;

FIG. 7A is a simplified diagram of a main component of a variable capacity-type gear pump according to the present invention before movement of the outer ring, FIG. 7B is a diagram in which the outer ring is rotated about the center Pa of the inner rotor, and FIG. 7C is a diagram in which the outer ring is rotated about the center Pb of the outer rotor;

FIG. 8A is a simplified diagram of a main component of a variable capacity-type gear pump according to the present invention in which the eccentric axial line La is rotated and FIG. 8B is a diagram illustrating an example of moving trajectories of a temporary lever when the eccentric axial line La is rotated;

FIG. 9 is a diagram illustrating a configuration example of a variable capacity-type gear pump design support device according to the present invention; and

FIG. 10A is a diagram of a variable capacity-type gear pump in which the eccentric axial line La is at an initial position, and FIG. 10B is a diagram of the variable capacity-type gear pump in which the eccentric axial line La is at the angle of 90 degrees.

### DESCRIPTION OF THE PREFERRED EMBODIMENTS

### Variable Capacity-Type Gear Pump

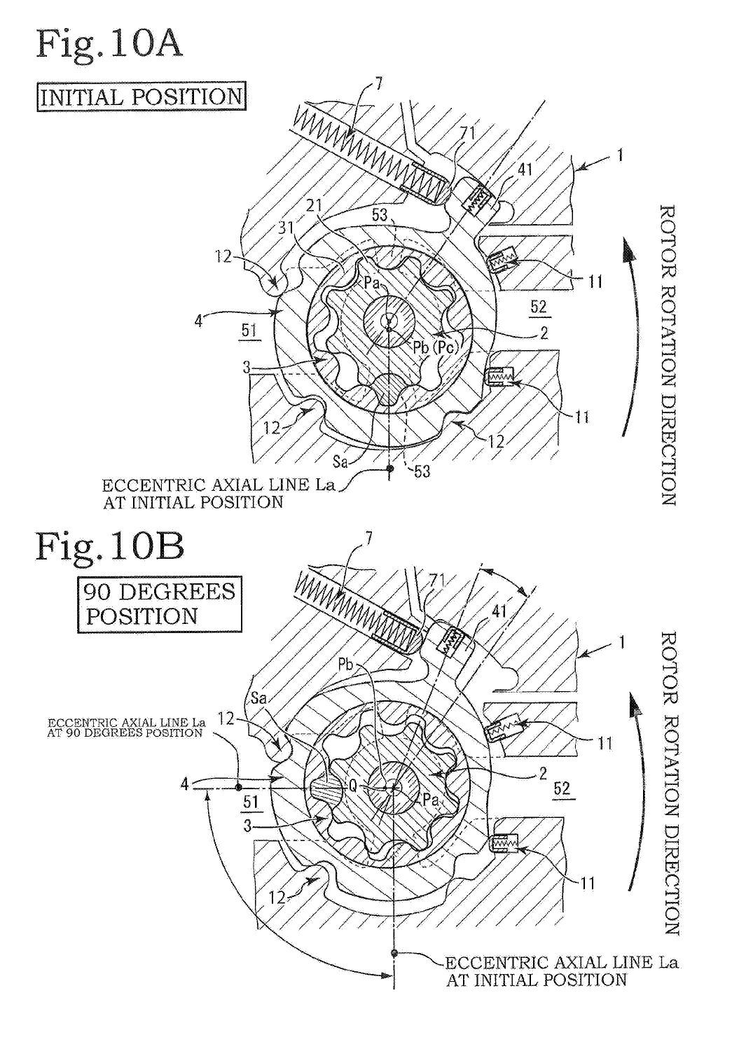

First, a variable capacity-type gear pump will be described. FIGS. 10A and 10B are diagrams illustrating an example of a main component of a variable capacity-type gear pump. The variable capacity-type gear pump includes an inner rotor 2 that rotates about a rotation shaft Pa fixed to a pump housing 1 and an outer rotor 3 that accommodates the inner rotor 2 and can freely rotate. The outer rotor 3 is not supported but is held from the periphery of an outer ring 4 so as to freely rotate. The outer ring 4 is supported by outer ring supporting tooth portions 12 so that predetermined movement can be realized.

The center Pb of the outer rotor 3 is always shifted by a fixed amount e in relation to a rotation shaft Pa. Further, an inner teeth 31 provided in the outer rotor 3 engages with an outer teeth 21 provided in the inner rotor 2, and the outer rotor 3 rotates with rotation of the inner rotor 2.

The engagement gap between the outer teeth 21 and the inner teeth 31 is filled with oil. Moreover, oil cannot pass through the contact point between the outer teeth 21 and the inner teeth 31. A segment that connects the rotation shaft Pa and the center Pb is referred to as an eccentric axial line La. One of the gaps under the eccentric axial line La has a largest gap volume (see a hatched portion Sa) among the respective gaps and the other gap has a smallest gap volume. In FIG. 10A, the gap space Sa has the largest gap volume and an uppermost portion in the drawing has the smallest gap volume which is approximately zero.

When the inner rotor 2 rotates in a counter-clockwise direction with such an arrangement, the outer rotor 3 also rotates in a counter-clockwise direction in engine with the inner rotor 2. The gap space formed by the gap between the two gears has a volume which increases in the counter-clockwise direction from the upper part of the drawing to reach the maximum at the lowermost portion and then decreases. In this case, the oil inside the gap causes a negative pressure on the left side of the lowermost gap and causes a positive pressure on the right side.

A suction port 51 and a discharge port 52 are provided with the outer rotor 3 interposed. A partition wall 53 is provided between the two ports so that oil cannot directly pass between the suction port 51 and the discharge port 52. The oil between the two ports can pass through a gap space between the two gears.

Here, when the pump is connected to an oil pan 5 (not illustrated) through the suction port 51 that communicates with the left-side gap, oil flows into the left-side gap through the suction port 51. Moreover, when the pump is connected to the oil pan 5 through the discharge port 52 that communicates with the right-side gap, oil flows out of the right-side gap through the discharge port 52.

As described above, there is no direct oil path between the suction port 51 and the discharge port 52. The two ports are connected through the gap between the gears through which the oil passes. With this configuration, when the inner rotor 2 and the outer rotor 3 rotate in the counter-clockwise direction, oil flows from the suction port 51 to the discharge port 52. An oil circulation path is formed by the oil pan 5. In this case, the shift of the outer rotor 3 is referred to as an initial shift position. Alternatively, it is said that the eccentric axial line La is at the initial position. Alternatively, it is said that the angle of the eccentric axial line La is 0 degree.

FIG. 10B illustrates a case in which the eccentric axial line La is rotated 90 degrees in the clockwise direction about the rotation shaft Pa. In this case, the largest gap space Sa is formed on the leftmost side and the gap space on the rightmost side is the smallest. In this state, the inner rotor 2 and the outer rotor 3 are rotated in the counter-clockwise direction. On the left side of the drawing, the gap space volume increases as the rotor rotates in the counter-clockwise direction to reach the largest volume and then decreases to return to its initial volume when the rotor reaches the lowermost side.

On the other hand, on the right side of the drawing, the gap space volume decreases as the rotor rotates in the counter-clockwise direction to reach the smallest volume and then increases to return to its initial volume when the rotor reaches the uppermost side. That is, although the gap space volume on the left and right sides varies, the volume returns to its original volume when the rotor rotates 180 degrees.

In this configuration, oil that is once sucked from the suction port 51 flows out through the suction port 51 again and oil that is sucked from the discharge port 52 flows out through the discharge port 52 again. Since this occurs repeatedly every 180 degrees of rotation, even when the inner rotor 2 and the outer rotor 3 are rotated in the counter-clockwise direction, the oil will not flow in a fixed direction as illustrated in FIG. 10A.

As described above, the position of the rotation shaft Pa of the inner rotor 2 is invariable in relation to the pump housing 1. Thus, the direction of the eccentric axial line La is determined by moving the center Pb of the outer rotor 3 by allowing the outer ring 4 to perform rotational movement and translational movement or a combination thereof. The amount of supplied oil is most efficient when the eccentric axial line La is at the initial position and the amount of supplied oil is the largest when the inner rotor 2 makes one rotation. On the other hand, the amount of supplied oil is zero when the eccentric axial line La is at the angle of 90 degrees. The direction of the eccentric axial line La is defined by a rotation angle about the rotation shaft Pa. In general, the variable capacity-type gear pump can change the amount of supplied oil per rotation of the inner rotor 2 by changing the eccentric axial line La between 0 degree and 90 degrees.

It is necessary to restrict the movement of the outer ring 4 in order to allow the outer ring 4 to perform desired movement. Thus, as illustrated in FIGS. 10A and 10B, the outer ring supporting tooth portions 12 formed of a convex portion is provided inside the pump housing 1 to restrict the movement of the outer ring 4. In order to control the movement of the outer ring 4, a lever 41 provided at an appropriate position and a compression spring 7 that biases the lever 41 are important. A chip seal 11 having a compression spring is also disposed to seal the oil.

### [Simplified Representation of Main Components of Variable Capacity-Type Gear Pump]

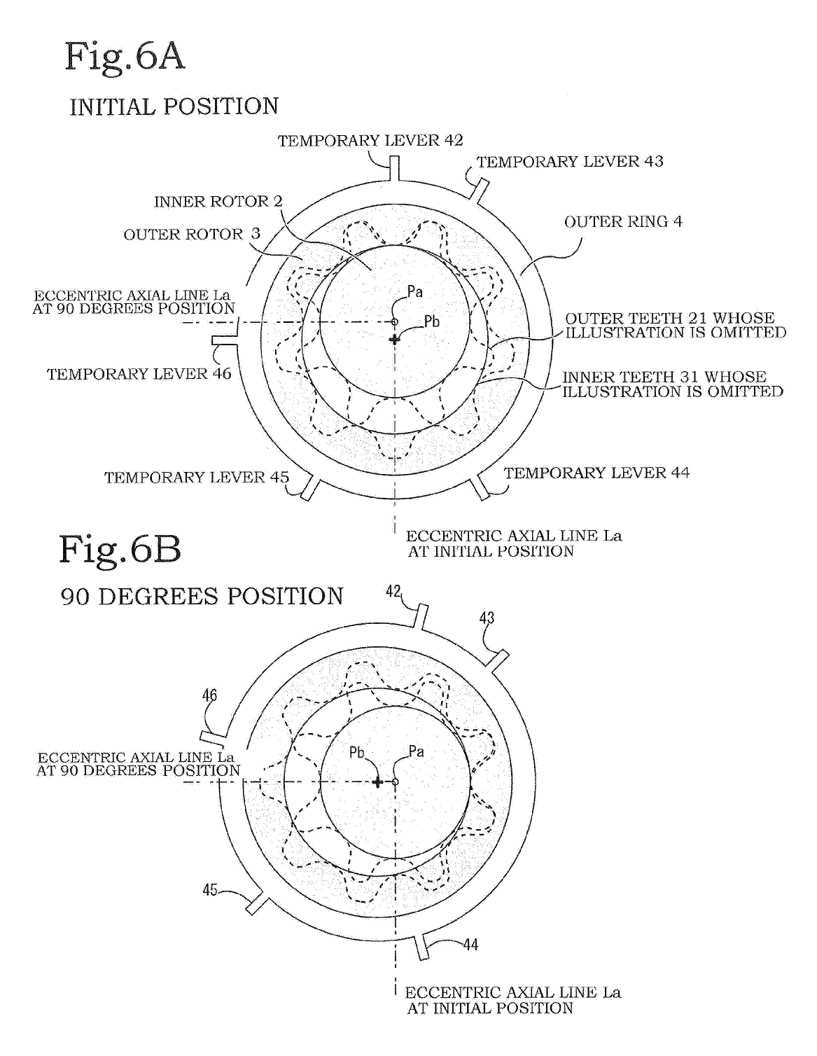

Hereinafter, the moving trajectory of the lever 41 provided on the outer ring 4 with movement of the outer ring 4 will be discussed mainly. The main components of the variable capacity-type gear pump are represented in a simplified manner as illustrated in FIGS. 6A and 6B. The position where the lever 41 is provided is determined based on the result of analysis described hereinafter, and it will be assumed that temporary levers 42, 43, 44, 45, and 46 are set. Moreover, the inner rotor 2 is represented by a circle as an envelope formed by the lowest portions of the troughs between the outer teeth 21 while the illustration of the outer teeth 21 is omitted. The outer rotor 3 is represented by a circle as an envelope formed by the highest portions of the peaks between the inner teeth 31 while the illustration of the inner teeth 31 is omitted.

FIG. 6A illustrates a positional relation among the inner rotor 2, the outer rotor 3, and the outer ring 4 when the eccentric axial line La is at the initial position. The gap Sa of the largest volume is formed on the lowermost side of the drawing (not illustrated). In this arrangement, the amount of supplied oil per rotation from the suction port 51 on the left side to the discharge port 52 on the right side is the largest although not illustrated. FIG. 6B illustrates an arrangement in which the eccentric axial line La is at the angle of 90 degrees with respect to the initial position. In this case, the gap Sa of the largest volume is formed on the left side of the drawing. In this arrangement, the amount of supplied oil from the suction port 51 to the discharge port 52 is zero.

### [Description of Movement Example of Outer Rotor and Outer Ring]

Next, the movement of the outer rotor 3 via the outer ring 4 will be described. As described above, the inner rotor 2 performs only rotation about the rotation shaft Pa but does not perform translational movement. On the other hand, the outer rotor 3 can perform rotational movement and translational movement on condition that the eccentricity e between the center Pb and the rotation shaft Pa is maintained.

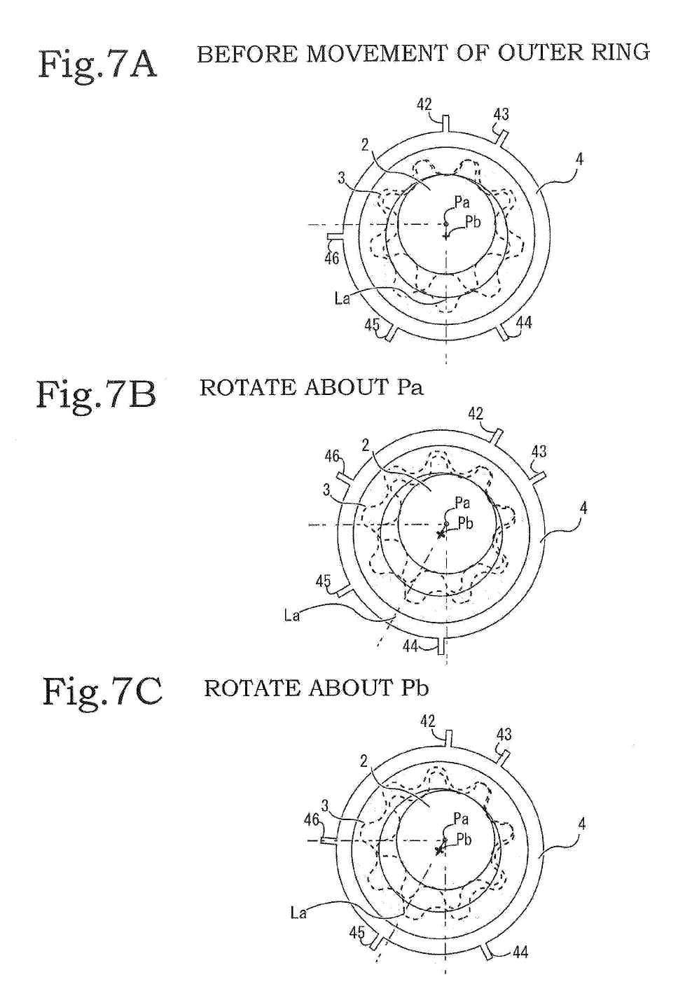

An example of the movement of the outer rotor 3 and the outer ring 4 will be described based on FIGS. 7A to 7C. FIG. 7A illustrates the state before movement, of the eccentric axial line La. For example, when the eccentric axial line La is rotated 30 degrees in the clockwise direction from the initial position, it is easy to understand that the outer rotor 3 and the outer ring 4 are rotated about the rotation shaft Pa of the inner rotor 2. With this movement, the eccentric axial line La is rotated by 30 degrees as illustrated in FIG. 7B.

Here, the outer ring 4 is freely rotatable in relation to the outer rotor 3. Thus, although the outer rotor 3 and the inner rotor 2 are in engagement and the rotation thereof is restricted, the outer ring 4 can freely rotate about the center Pb. When the outer ring 4 is rotated 25 degrees in the counter-clockwise direction, the state of FIG. 7C is created. That is, an example in which the outer ring 4 is rotated 30 degrees in the clockwise direction about the rotation shaft Pa and is then rotated 25 degrees in the counter-clockwise direction about the center Pb is illustrated. In this state, the angle of the eccentric axial line La maintains 30 degrees.

Although the movement of the outer ring 4 has been described in two steps for the sake of convenience, the movements may be performed simultaneously. According to such a movement, it is possible to decrease the movement amount of the outer ring 4 as compared to the rotational movement about the rotation shaft Pa only and it is advantageous to designing the variable capacity-type gear pump in a compact size. Naturally, the movement of the outer ring 4 is not limited to this but other movement method may be used.

### [Trajectory of Temporary Lever of Outer Ring]

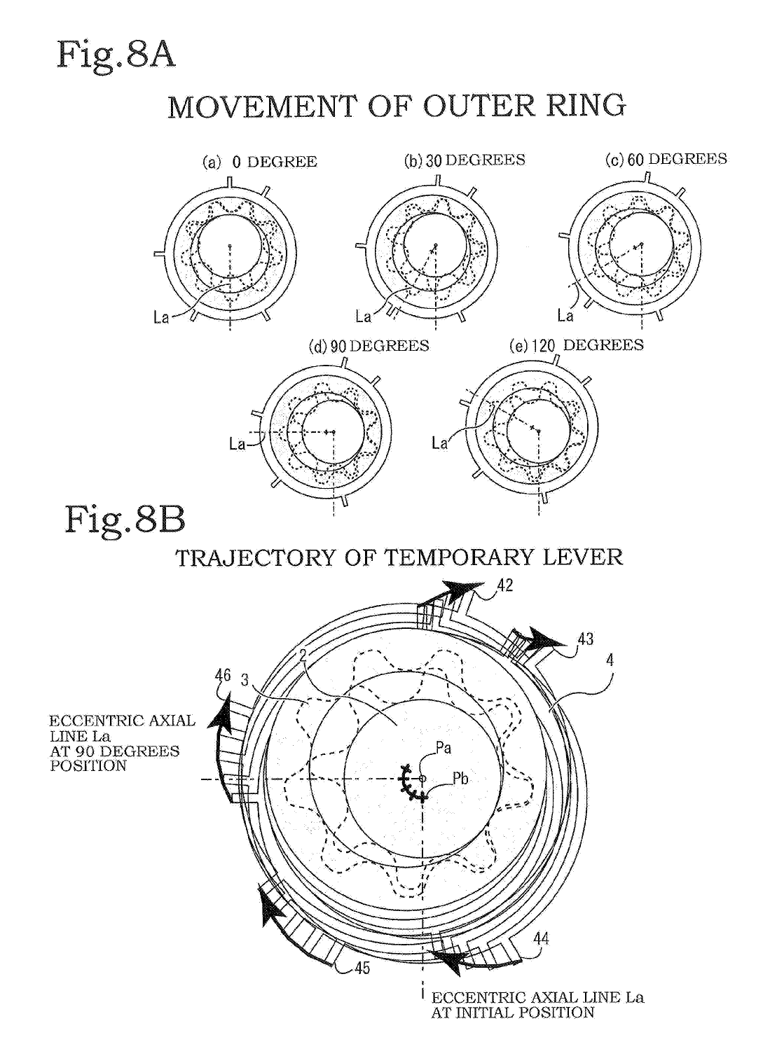

The trajectory of the temporary lever of the outer ring 4 will be described. FIG. 8A illustrates the states in which the eccentric axial line La is rotated from 0 degree (initial position) to 120 degrees in steps of 30 degrees. In FIG. 8B, the moving trajectories are illustrated by arrows while illustrating the outer rings 4 at the angles 0 degree to 120 degrees in a superimposed manner. It can be understood from the difference in the direction, length, and curve shape of the arrows illustrated in the drawing that the temporary lever moves differently depending on a position.

In this example, five trajectories of the temporary levers 42 to 46 are displayed every predetermined interval. However, similarly, temporary levers may be provided continuously on the circumferential portion of the outer ring 4 and the moving trajectories thereof may be calculated. When the outer ring 4 is moved continuously along these trajectories, it is possible to change the angle of the eccentric axial line La in continuous angular values rather than the discrete values such as 0 degree, 30 degrees, 60 degrees, and 120 degrees.

For example, in order to realize such a movement of the outer ring 4 as illustrated in FIG. 8A, the circumferential portion of the outer ring 4 on which the temporary levers 42 to 46 are provided may move along the moving trajectories illustrated in FIG. 8B. Thus, outer ring supporting tooth portions such as restriction walls having a tooth shape are formed inside the pump housing 1 so that the outer ring 4 moves along the moving trajectories. The outer ring supporting tooth portions 12 illustrated in FIGS. 10A and 10B are examples of the outer ring supporting tooth portion.

The movement of the outer ring 4 can be controlled by biasing one or two or more positions of the circumferential portion of the outer ring 4 corresponding to the moving trajectories using a compression spring or biasing the same using a hydraulic pressure confronting the compression spring 7. Such a biasing portion such as the compression spring 7 is preferably provided at a position corresponding to a linear trajectory among the moving trajectories. This is because a linear trajectory can efficiently apply the repulsive force of the compression spring 7.

Therefore, an object of the present invention is to provide a variable capacity-type gear pump designing method, a design support program, and a design support device for calculating the moving trajectory of the circumferential portion of the outer ring 4, moving according to a movement rule of the outer ring 4 to determine the linearity of the moving trajectory and determining appropriateness of the position at which a spring that biases the outer ring 4 is to be provided.

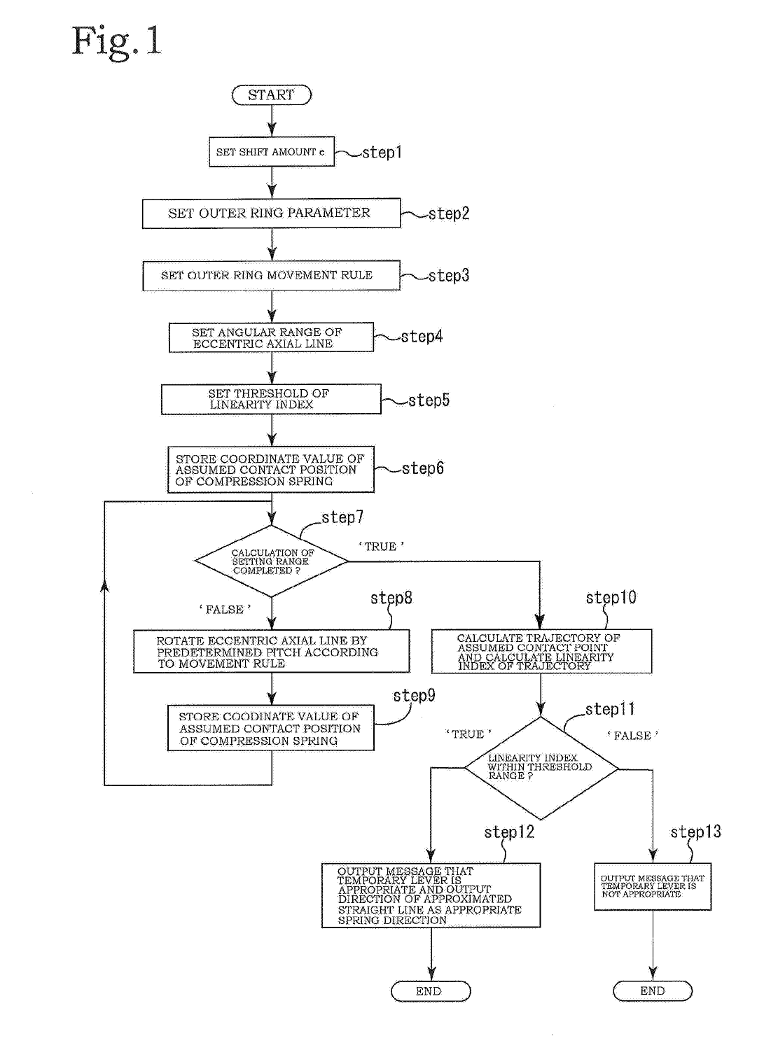

FIG. 1 illustrates a flowchart of an embodiment of a variable capacity-type gear pump designing method of the present invention, executed on a computer. After the process flow starts, a shift amount e is set (step 1). The shift amount e is a shift amount of Pb from Pa as described above. Since the rotation shaft Pa of the inner rotor 2 is fixed in relation to the pump housing 1, when the shift amount e is set, the movement range of the center Pb (the center of rotation of the outer ring) of the outer rotor 3 is defined.

Subsequently, an outer ring parameter is set (step 2). The outer ring parameter is the coordinate of an imaginary contact point on a temporary lever provided on the circumferential portion of the outer ring 4. The contact point is a point with which it is assumed that the compression spring 7 makes contact. A specific setting example will be described later. One temporary lever may be provided and a plurality of temporary levers may be provided.

Subsequently, an outer ring movement rule is set (step 3). The movement rule defines a method of moving the outer ring 4 in order to rotate the eccentric axial line La by a predetermined angle. A specific example of the movement rule will be described later.

Subsequently, an angular range in which the eccentric axial line La is rotated is set (step 4). Although the angular range is generally between 0 degree and 90 degrees, the angular range is not limited thereto but may be between 0 degree and 120 degrees, for example.

Subsequently, a threshold of an index indicating the linearity is set (step 5). The Poisson's correlation coefficient can be used as the index which is a number indicating whether trajectory data is linear or not. Trajectory data may be approximated to a straight line using a least-squares method and an error between the straight line and the trajectory data may be used as an index. A numerical value that corresponds to a linearity evaluation index to be applied and is a lower limit of linearity allowed on design of the variable capacity-type gear pump of the present invention is set as a threshold. The numerical values input in steps 1 to 5 are input by a user via a graphical user interface or the like provided in the computer. Alternatively, these numerical values may be stored in a magnetic disk or the like as a file and may be read by an arithmetic unit.

The coordinate value of the contact point of the compression spring 7 when the outer ring 4 is set to the initial position (that is, when the eccentric axial line La is at the angle of 0 degree) (step 6). As described above, the contact point is a point with which it is assumed that the compression spring 7 makes contact.

Step 7 is a conditional branching process. When calculation of the angular range of the eccentric axial line La set in step 4 is completed, the flow proceeds to step 10. When calculation is not completed, the flow proceeds to step 8. In this example, since the calculation is not completed, the flow proceeds to step 8.

The outer ring 4 is moved along the movement rule determined in step 3 so that the eccentric axial line La can be rotated by a predetermined pitch (step 8). The predetermined pitch may be 1 degrees or more or smaller, for example. The predetermined pitch may be selected in the setting process of step 3 or 4.

The coordinate value of the contact point after the eccentric axial line is rotated by the predetermined pitch in the previous step is stored (step 9). The contact point is an assumed contact point of the compression spring 7 and the coordinate value thereof is stored. After that, if the condition is satisfied in the conditional branch of step 7 (that is, if “True”), the flow proceeds to step 10.

After calculation of the setting range is completed and all coordinate values of the contact points are stored, the trajectory of the assumed contact point is calculated from the coordinate values. The degree to which the trajectory deviates from a straight line or approaches the straight line is calculated as the index of linearity (step 10). A specific example of calculating the index of linearity will be described later.

Step 11 is a conditional branching process. If the linearity index calculated in step 10 is within the range of the threshold determined in step 5, it is determined that the linearity condition is satisfied and the flow proceeds to step 12. If not (that is, if “False”), the flow proceeds to step 13.

Step 12 is the case in which the linearity of the trajectory is within the range. In this case, a message that the position of the temporary lever is appropriate for providing the lever 41 is output. The direction of the approximated straight line of the trajectory may be output as the appropriate direction of the spring. When this information is output, the process flow ends.

Step 13 is the case in which the linearity of the trajectory is outside the range. In this case, a message that the position of the temporary lever is not appropriate for providing the lever 41 is output and the entire process flow ends.

### [Outer Ring Parameter]

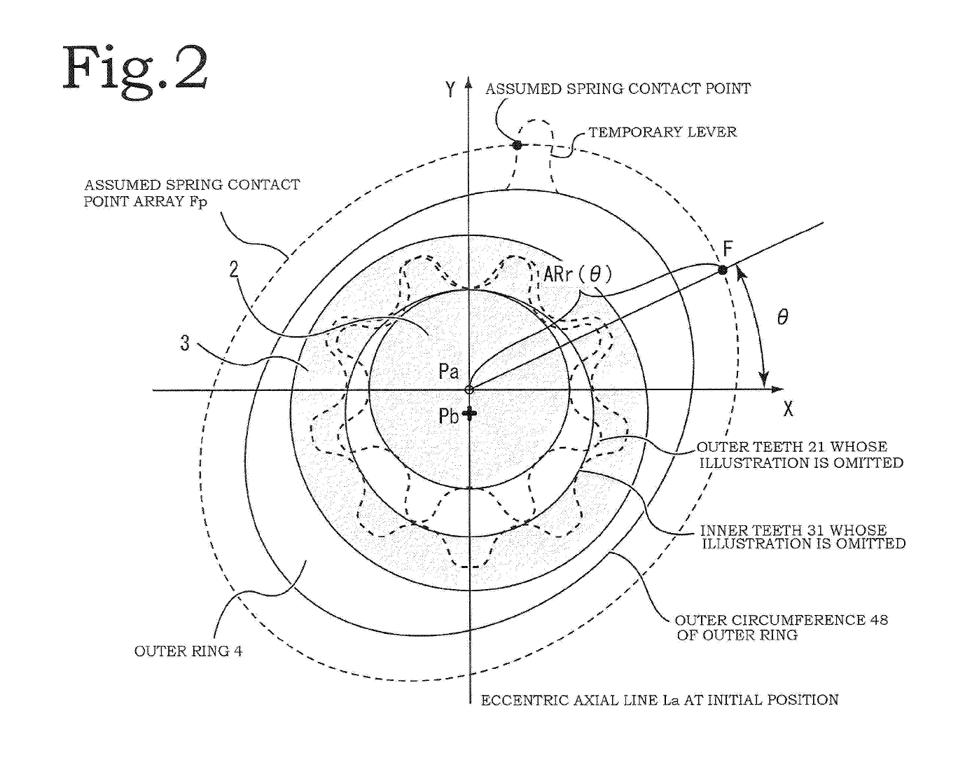

Next, the outer ring parameter will be described. The outer ring parameter is a parameter that defines the coordinate of an imaginary contact point on a temporary lever provided on the circumferential portion of the outer ring 4. FIG. 2 is a diagram illustrating an example of a coordinate system of an outer ring according to the variable capacity-type gear pump designing method of the present invention. One temporary lever may be provided and a plurality of temporary levers may be provided.

FIG. 2 illustrates the simplified inner rotor 2, the outer rotor 3, and the outer ring 4. Pa is the center of rotation of the inner rotor and Pb is the center of rotation of the outer rotor 3 and the outer ring 4. Illustrations of the outer teeth 21 and the inner teeth 31 are omitted. Although an envelope formed by the lowest portions of the troughs of the outer teeth 21 forms a circle, the outline of the inner rotor 2 in the drawing is circular. Although an envelope formed by the highest portions of the peaks of the inner teeth 31 forms a circle, the outline of the outer rotor 3 in the drawing is circular. However, an envelope formed by the lowest portions of the troughs of these teeth forms a circle.

The coordinate system of the outer ring has the origin at Pa and the Y-axis thereof extends along the eccentric axial line La at the initial position (that is, at the angle of 0 degree). The positive direction of the Y-axis extends from Pb to Pa (the upward direction of the drawing). The X-axis passes through Pa in the direction orthogonal to the Y-axis, and the positive direction of the X-axis extends toward the right side of the drawing. Since an outer circumference 48 of the outer ring 4 is not a true circle, the outer ring 4 is depicted in an approximately elliptical shape.

When the lever 41 is provided on the outer circumferential portion of the outer ring 4 and is biased by the compression spring 7, the contact point between the compression spring 7 and the lever 41 is located closer to the outer side than the outer circumferential portion. A group of contact points located closer to the outer side by the distance is referred to as an assumed spring contact point array Fp. That is, Fp is an array of assumed spring contact points of the lever. The outer ring parameter is the (X,Y) coordinate of the position at which the temporary lever is provided within the assumed spring contact point array Fp when the outer ring 4 is at the initial position. Since a plurality of temporary levers may be provided, the outer ring parameter may be a plurality of sets of (X,Y) coordinates.

The outer ring parameter may be based on polar coordinates. Pa is defined as the origin and the direction of a radius vector is defined by a deflection angle θ from the X-axis, and the point on Fp is determined by the distance ARr(θ) of the radius vector. The outer ring parameter may be represented by ARr(θ). Here, 0≦θ<360 degrees.

### [Movement Rule of Outer Ring 4]

An example of the movement rule of the outer ring 4 will be described. The followings are examples of the movement rule of the outer ring 4. An angle by which the outer ring 4 is rotated about Pa and an angle by which the outer ring 4 is rotated about Pb may be designated and used as the movement rule. Further, the ratio of the rotation angle about Pb to the rotation angle about Pa may be used as the movement rule.

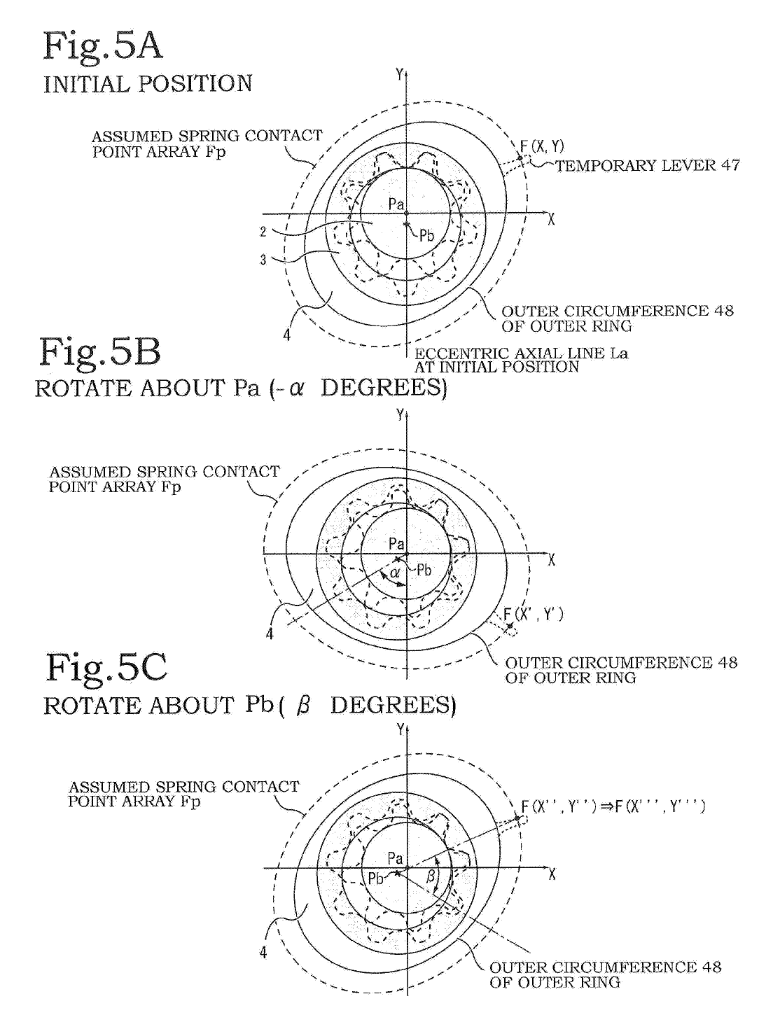

FIGS. 5A to 5C are diagrams illustrating examples of the movement rule for the outer ring 4. In this example, the counter-clockwise direction is referred to as a positive rotation direction and the clockwise direction is referred to as a negative rotation direction. FIG. 5A is the diagram of the outer ring 4 at the initial position in which the inner rotor 2 of which the illustration of the outer teeth 21 are omitted, the outer rotor 3 of which the illustration of the inner teeth 31 are omitted, and the outer ring 4 are illustrated. A broken line indicates the assumed spring contact point array Fp. When the eccentric axial line La is rotated by −α degrees, the outer ring 4 is rotated −α degrees about the rotation shaft Pa of the inner rotor 2 (FIG. 5B).

Subsequently, the outer ring 4 is rotated β degrees about the center Pb of the outer rotor 3 (FIG. 5C). FIG. 5C illustrates a state in which the movement of the outer ring 4 is completed according to the movement rule. A predetermined ratio between α and β may be determined. For example, when α=60 and the predetermined ratio is 5/6, β=50. A sign may be included, and if α′=−60 and the ratio is −5/6, the movement rule may be determined so that β′=50. Hereinabove, the movement rule of the outer ring 4, for rotating the eccentric axial line La by α degrees has been described. When the outer ring 4 is moved according to this rule, the eccentric axial line La can be rotated by a desired angle.

### [Calculation of Contact Point Trajectory]

As described above, the contact point is an assumed contact position of the compression spring 7 and is on the assumed spring contact point array Fp. For example, in the case of the temporary lever 47 in FIG. 5A, the contact point is the point F. (X′,Y′) is the coordinate obtained when the coordinate (X,Y) is rotated by −α degrees about the Pa. The conversion from (X,Y) to (X′,Y′) can be realized by multiplying the coordinate (X,Y) by a rotation matrix.

As described above, since Pb is shifted by e from Pa, the coordinate of Pb in the initial state is (0,−e). The coordinate after the coordinate is rotated by −α degrees is obtained by multiplying the coordinate by the rotation matrix. This state is illustrated in FIG. 5B.

Subsequently, the coordinate is rotated about Pb. However, prior to this, the coordinate needs to be converted to a coordinate system of which the origin is at Pb. The conversion may be realized by decreasing the coordinate value of Pb. Subsequently, the coordinate of the contact point F when the coordinate is rotated by β degrees about Pb is obtained by multiplying the coordinate by the rotation matrix. This coordinate value is referred to as F(X″,Y″).

However, F(X″,Y″) is defined with the origin at Pb. Thus, the coordinate needs to be converted to a coordinate system of which the origin is at the original origin (that is, Pa). This may be realized by adding the signed value decreased when the origin of the coordinate value is changed from Pa to Pb. The coordinate value obtained in this way is a final coordinate F(X′″,Y′″) of the contact point F illustrated in FIG. 5C.

Hereinabove, the coordinates of the contact point F before and after the outer ring 4 is moved according to the movement rule of the outer ring 4 in order to rotate the eccentric axial line La by α degrees have been described. In step 6 of the flowchart illustrated in FIG. 1, the coordinate F(X,Y) of the contact point F in the initial state is stored. In step 9, the coordinate (that is, the coordinate value of F(X′″,Y′″)) after the movement for rotating the eccentric axial line La by a predetermined angle is realized is stored.

### [Trajectory Data]

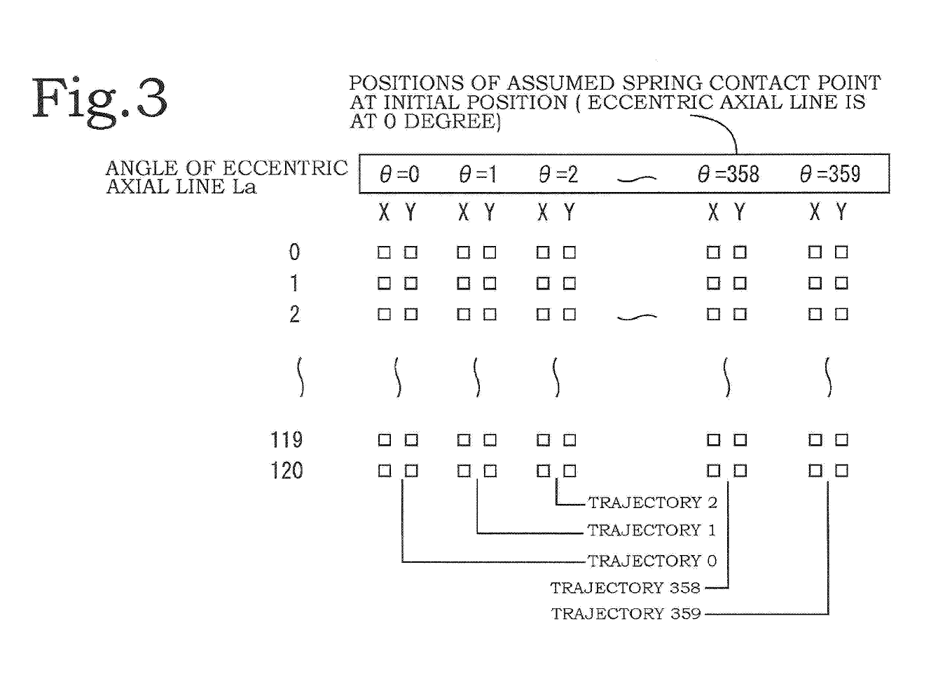

As described in the branch condition in step 7 of the flowchart of FIG. 1, when calculation of the setting range (calculation and storage of the coordinate of the contact point after movement of the outer ring 4) is completed, the trajectory data of the contact point is obtained (step 10). The trajectory data can be expressed by a table in FIG. 3, for example.

FIG. 3 is a table illustrating the trajectories of the assumed spring contact point, and the vertical column on the leftmost side indicates the angle of the eccentric axial line La. In FIG. 3, an angular range of 0 to 120 degrees with an interval of 1 degrees is illustrated. The angular range and the interval may be determined appropriately. The first row of the table indicates the position of the assumed spring contact point when the outer ring 4 is at the initial position (that is, the eccentric axial line La is at the angle of 0 degree). In this table, the positions of 360 assumed spring contact points at an interval of 1 degrees for θ (=0 to 359 degrees) are illustrated. This means that 360 temporary levers are provided at an interval of 1 degrees. Moreover, 360 trajectories corresponding to the angles of 0 to 359 are formed.

In FIG. 3, it is assumed that coordinate values are described in the blanks □□ outside the leftmost column and the first row. The coordinate values are based on an orthogonal coordinate system. The first coordinate of each item of the trajectory data is the position of the assumed spring contact point at the initial position. When this coordinate is expressed by a polar coordinate, the coordinate can be expressed as θ=0, 1, 2, . . . , 358, and 359 as described on the first row.

### [Linearity Index]

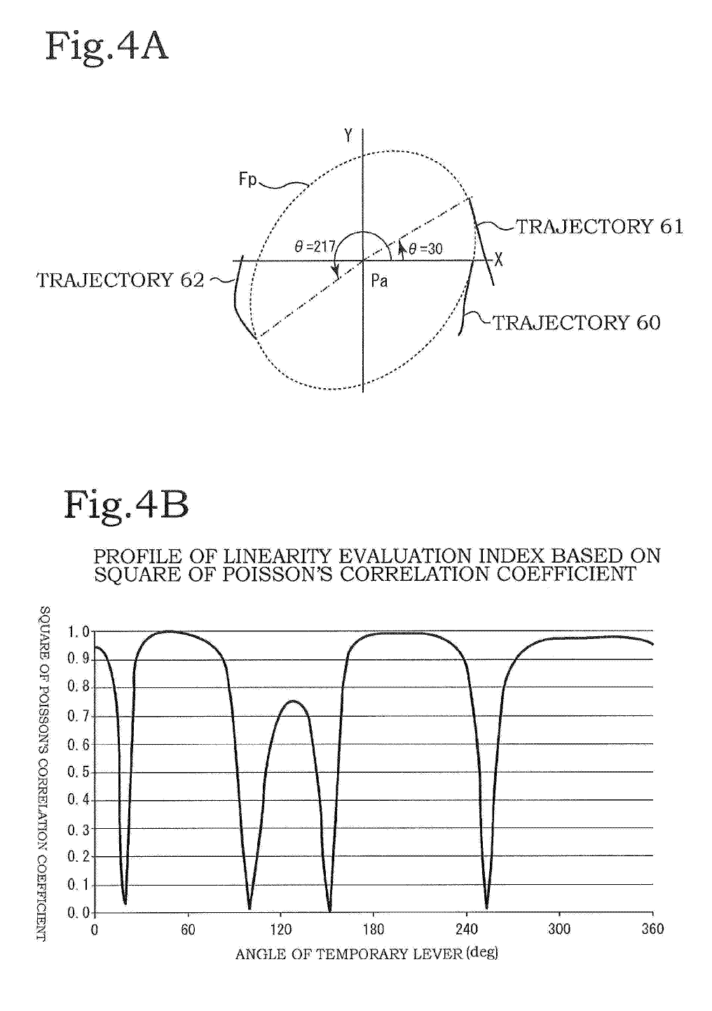

Subsequently, an example of calculation of the linearity index from the trajectory data, performed in step 10 will be described. Prior to this, a specific example of the trajectory is illustrated in FIG. 4A. FIG. 4A illustrates the trajectory of a contact point formed when the outer ring 4 is moved to rotate the eccentric axial line La by 0 to 120 degrees. Trajectory 60 is a trajectory when the temporary lever is provided at a portion of the outer ring 4 corresponding to θ=0 degree, Trajectory 61 is a trajectory when the temporary lever is provided at a portion of the outer ring 4 corresponding to θ=30 degrees, and Trajectory 62 is a trajectory when the temporary lever is provided at a portion of the outer ring 4 corresponding to θ=217 degrees. However, the movement rule of the outer ring 4 is that the outer ring 4 is rotated by γ degrees about Pa and is then rotated by γ×⅔ degrees about Pb.

The Poisson's correlation coefficient can be applied to the linearity index of the trajectory data. The Poisson's correlation coefficient is calculated as below. The X bar and the Y bar indicate the mean values.

$$r = \frac{\sum ( X - \overline{X} ) ( Y - \overline{Y} )}{\sqrt{\sum {( X - \overline{X} )}^{2} \sum {( Y - \overline{Y} )}^{2}}} \qquad [ Expression 1 ]$$

The trajectory data can be regarded as a set of the coordinate values on X and Y-axes. Thus, the X-coordinate value and the Y-coordinate value are substituted into Expression 1 to calculate the correlation coefficient r of each item of the trajectory data, and the linearity index is obtained based on the correlation coefficient. Since the correlation coefficient has a positive or negative sign, the square of the correlation coefficient r can be used as the linearity index of the trajectory data in the variable capacity-type gear pump designing method of the present invention.

The linearity index has the value of 0 to 1, and the better the linearity, the closer to 1. For example, the linearity indices obtained by the square of the Poisson's correlation coefficient, of the trajectories 60, 61, and 62 in FIG. 4A are 0.982, 0.997, and 0.268, respectively. According to the indices, the linearity index of the trajectory 61 is 0.997 that is closest to 1 and is evaluated as having the best linearity. Moreover, the linearity index of the trajectory 62 is 0.268 and is evaluated as having the worst linearity. Further, the linearity index of the trajectory 60 is 0.982 and is evaluated as having the second best linearity following the trajectory 61. The linearity evaluation based on the square of the Poisson's correlation coefficient matches the linearity evaluation based on visual inspection, and the effect thereof is obvious.

The X and Y coordinate values may be approximated to a straight line using a least-squares method, errors between the coordinate values on this straight line and the coordinate values of the trajectory data may be calculated, and the sum of the absolute values or the squares of the errors may be calculated, and a value obtained by dividing the sum by the number of items of the data may be used as the linearity index of the X and Y coordinate values of the trajectory data. In this case, the small the sum, the better the linearity. For example, the values obtained by dividing the sums of the squares of the errors from the approximated straight lines of the trajectories 60, 61, and 62 by the number of items of the data are 0.923, 0.215, and 36.38, respectively. From this, it can be understood that the smaller the numerical value, the better the linearity of the trajectory.

FIG. 4B illustrates a profile of the linearity index based on the square of the Poisson's correlation coefficient according to another movement rule of the outer ring. The horizontal axis represents the position (angle) of a temporary lever and the vertical axis represents the square of the Poisson's correlation coefficient as the linearity evaluation index. For example, in the variable capacity-type gear pump designing method of the present invention, the position of a temporary lever at which the square of the Poisson's correlation coefficient has a value of 0.9 or more can be output as a position suitable for providing the lever 41. Hereinabove, an example of calculation of the linearity index of the trajectory of the assumed contact point performed in step 10 has been described.

Step 12 is a process for a case in which the linearity of the trajectory data is allowable and is within a threshold range. In this case, an approximated straight line may be calculated for the trajectory according to a least-squares method or the like and a message that the compression spring 7 is to be provided in this direction may be output.

The variable capacity-type gear pump designing method of the present invention has an effect that the moving trajectory of an assumed spring contact point on a temporary lever provided on an outer circumference of the outer ring when changing the direction of the eccentric axial line La is calculated, and the position of the temporary lever at which the moving trajectory forms an approximately straight line can be found by calculation. When a lever is provided at the position of the temporary lever at which the moving trajectory forms an approximately straight line and the compression spring is disposed on the trajectory that forms the approximately straight line, the repulsive force of the compression spring can be efficiently transmitted to the lever and the amount of supplied oil as designed can be realized.

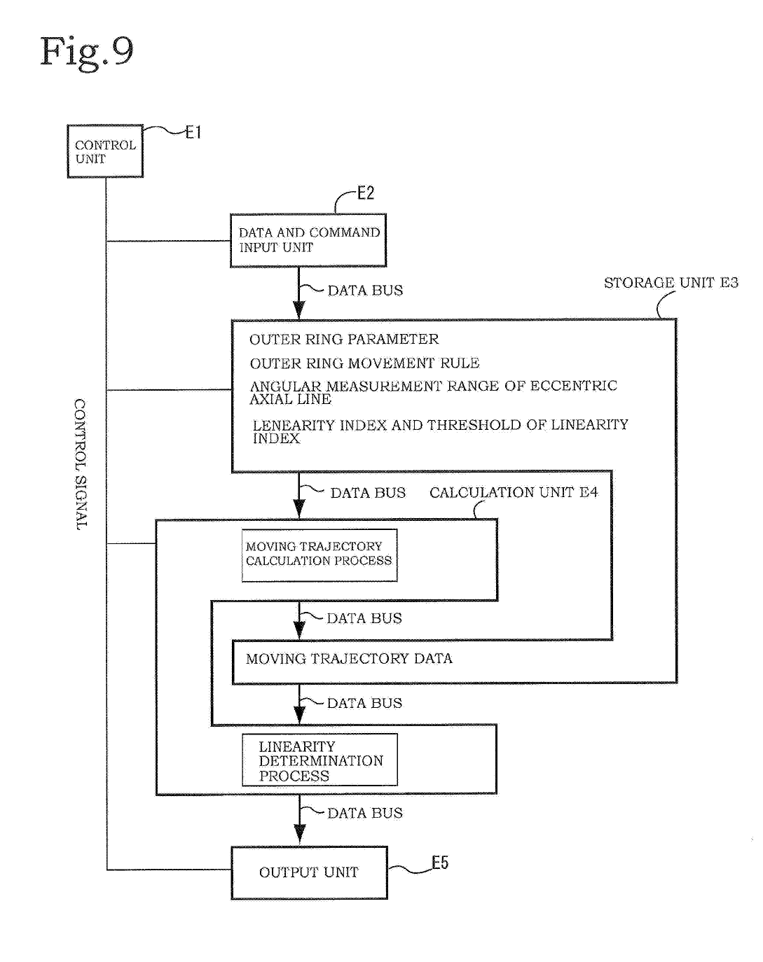

The variable capacity-type gear pump designing method of the present invention can be realized by a variable capacity-type gear pump design support device illustrated in FIG. 9. The variable capacity-type gear pump design support device of the present invention includes at least a data and command input unit E2, a storage unit E3, a calculation unit E4, and an output unit E5. Moreover, the variable capacity-type gear pump design support device further includes a control unit E1 that controls these components. The control unit E1 may also function as the calculation unit E4. Input and output of data between the data and command input unit E2, the storage unit E3, the calculation unit E4, and the output unit E5 is performed via a data bus. The process is performed according to the flowchart illustrated in FIG. 1.

The variable capacity-type gear pump design support device of the present invention receives data to be set in steps 1 to 5 from the data and command input unit E2. That is, the shift amount e, the outer ring parameter, the outer ring movement rule, the angular range and the angular pitch of the eccentric axial line La to be measured, the linearity index, and the threshold that is allowable as being “linear” are input. These items of data are stored in the storage unit E3.

When a user inputs a command for starting calculation from the data and command input unit E2, the command is sent to the calculation unit E4 via the control unit E1. The calculation unit E4 starts a calculation process based on the command and calculates the moving trajectory of the assumed spring contact point when the eccentric axial line La rotates a predetermined angle.

The calculation unit E4 performs the calculation using the outer ring parameter, the outer ring movement rule, and the angular measurement range of the eccentric axial line La, which are stored in advance in the storage unit E3. Since the moving trajectory of the assumed spring contact point is calculated by the process of the calculation unit E4, the calculated moving trajectory is stored in the storage unit E3 as moving trajectory data. The moving trajectory data is configured as the trajectory table of the assumed spring contact point described with reference to FIG. 3.

When the moving trajectory data is obtained, the calculation unit E4 performs a linearity determination process on the trajectory data. In this process, a linearity evaluation index calculation method stored in advance in the storage unit E3 and the threshold information of the linearity index which is an allowable range of the linearity as well as the moving trajectory data stored in the storage unit E3 are used. When the linearity of the moving trajectory data is within an allowable range, a message that the position of the temporary lever associated with the moving trajectory data can be used as the position of the lever 41 is output from the output unit E5, and the direction of the approximated straight line of the moving trajectory data is output from the output unit E5 as the direction in which the compression spring 7 can be provided. The output format may be a text data file and the data may be output via a display or another general output device.

The variable capacity-type gear pump design support device of the present invention can construct a variable capacity-type gear pump design support device. The variable capacity-type gear pump designing method of the present invention has an effect that the moving trajectory of an assumed spring contact point on a temporary lever provided on an outer circumference of the outer ring when changing the direction of the eccentric axial line La is calculated, and the position of the temporary lever at which the moving trajectory forms an approximately straight line can be found by calculation. When a lever is provided at the position of the temporary lever at which the moving trajectory forms an approximately straight line and the compression spring 7 is disposed on the trajectory that forms the approximately straight line, the repulsive force of the compression spring 7 can be efficiently transmitted to the lever and the amount of supplied oil as designed can be realized.

The variable capacity-type gear pump design support device of the present invention can be realized as a program operating on a computer. A variable capacity-type gear pump design support program of the present invention operates on a computer according to the flowchart illustrated in FIG. 1. The computer includes at least a data and command input unit E2, a storage unit E3, a calculation unit E4, and an output unit E5. Moreover, the computer further includes a control unit E1 that controls these components. The control unit E1 may also function as the calculation unit E4. Input and output of data between the data and command input unit E2, the storage unit E3, the calculation unit E4, and the output unit E5 is performed via a data bus.

The variable capacity-type gear pump design support program of the present invention can construct a variable capacity-type gear pump design support device by installing the program on a computer that users are familiar with. The variable capacity-type gear pump design support device has an effect that the moving trajectory of an assumed spring contact point on a temporary lever provided on an outer circumference of the outer ring when changing the direction of the eccentric axial line La is calculated, and the position of the temporary lever at which the moving trajectory forms an approximately straight line can be found by calculation. When the lever 41 is provided at the position of the temporary lever at which the moving trajectory forms an approximately straight line and the compression spring 7 is disposed on the trajectory that forms the approximately straight line, the repulsive force of the compression spring 7 can be efficiently transmitted to the lever 41 and the amount of supplied oil as designed can be realized.

The contact point between the temporary lever and the compression spring 7 and the contact point between the lever 41 and the compression spring 7 mean a case in which the lever (the temporary lever or the lever 41) and the compression spring 7 are in direct contact with each other. Further, as illustrated in FIGS. 10A and 10B, the contact point means a case in which the compression spring 7 acts on the lever 41 indirectly with a piston 71 interposed.

1. A variable capacity-type gear pump designing method comprising:
constructing a numerical value calculation model on a memory of a computer, the model calculating an operation of a variable capacity-type gear pump including an inner rotor, an outer rotor, an outer ring that rotatably accommodates and holds the outer rotor, and a compression spring that controls movement of the outer ring;
providing one or two or more temporary levers on the outer ring in the numerical value calculation model and assuming that contact points of the compression spring are located on the temporary levers;
defining a movement rule of allowing the outer ring to perform translational movement, rotational movement, or a combination of the translational movement and the rotational movement and storing the movement rule on the memory of the computer;
moving the outer ring based on the movement rule by calculation of the computer and calculating positional coordinate values of the contact points over the moving range to obtain a set of coordinate values; and
determining appropriateness of the position of the temporary lever based on a statistical amount obtained by statistical processing on the set of coordinate values.

2. The variable capacity-type gear pump designing method according to claim 1, wherein
the set of coordinate values is used as moving trajectories and a linearity index value is calculated from the moving trajectories, and
the appropriateness of the position of the temporary lever is determined based on whether the linearity index value is within a predetermined range of linearity index values.

3. The variable capacity-type gear pump designing method according to claim 2, wherein
the linearity index value is the sum or the mean of absolute values of linear approximation errors between variables which are the coordinate values.

4. The variable capacity-type gear pump designing method according to claim 2, wherein
the linearity index value is the sum or the mean of squares of linear approximation errors between variables which are the coordinate values.

5. The variable capacity-type gear pump designing method according to claim 2, wherein
the linearity index value is the square of a correlation coefficient between variables which are the coordinate values.

6. The variable capacity-type gear pump designing method according to claim 5, wherein
the predetermined range of linearity index values is set such that the square of the correlation coefficient is 0.9 or more.

7. The variable capacity-type gear pump designing method according to claim 2, wherein
when the linearity index value is within the predetermined range of linearity index values, a direction of an approximated straight line between variables which are the coordinate values is used as a direction of the compression spring.

8. A variable capacity-type gear pump design support program for causing a computer to perform functions, comprising:
constructing a numerical value calculation model for calculating an operation of a variable capacity-type gear pump including an inner rotor, an outer rotor, an outer ring that rotatably accommodates and holds the outer rotor, and a compression spring that controls movement of the outer ring;
providing one or two or more temporary levers on the outer ring in the numerical value calculation model and assuming that contact points of the compression spring are located on the temporary levers;
defining a movement rule of allowing the outer ring to perform translational movement, rotational movement, or a combination of the translational movement and the rotational movement;
moving the outer ring based on the movement rule and calculating positional coordinate values of the contact points over the moving range to obtain moving trajectories;
calculating a linearity index value from the moving trajectories; and
determining appropriateness of the position of the temporary lever based on whether the calculated linearity index value is within a predetermined range of linearity index values.

9. A variable capacity-type gear pump design support device including a control unit, a data and command input unit, a storage unit, a calculation unit, and an output unit, the device performing:
constructing a numerical value calculation model on the storage unit, the model calculating an operation of a variable capacity-type gear pump including an inner rotor, an outer rotor, an outer ring that rotatably accommodates and holds the outer rotor, and a compression spring that controls movement of the outer ring;
providing one or two or more temporary levers on the outer ring in the numerical value calculation model and assuming that contact points of the compression spring are located on the temporary levers;
defining a movement rule of allowing the outer ring to perform translational movement, rotational movement, or a combination of the translational movement and the rotational movement and storing the movement rule on the storage unit;
moving the outer ring based on the movement rule in use of the calculation unit and calculating positional coordinate values of the contact points over the moving range to obtain moving trajectories;
calculating a linearity index value from the moving trajectories in use of the calculation unit; and
determining appropriateness of the position of the temporary lever based on whether the calculated linearity index value is within a predetermined range of linearity index values.

10. A variable capacity-type gear pump including an inner rotor, an outer rotor, an outer ring that rotatably accommodates and holds the outer rotor, and a compression spring that biases a lever provided on the outer ring to control movement of the outer ring, wherein
the square of a correlation coefficient between variables which are positional coordinates that form a trajectory of a contact point between the lever and the compression spring in a movement range of the outer ring is 0.9 or more, and the compression spring is provided on the trajectory in a direction identical to a direction of the trajectory.

11. A variable capacity-type gear pump including an inner rotor, an outer rotor, an outer ring that rotatably accommodates and holds the outer rotor, and a compression spring that biases a lever provided on the outer ring to control movement of the outer ring, wherein
in a numerical value calculation model for calculating an operation of the variable capacity-type gear pump including the inner rotor, the outer rotor, the outer ring, and the compression spring, one or two or more temporary levers are provided on the outer ring and it is assumed that contact points of the compression spring are located on the temporary levers,
a movement rule of allowing the outer ring to perform translational movement, rotational movement, or a combination of the translational movement and the rotational movement is defined,
the outer ring is moved based on the movement rule and positional coordinate values of the contact points over the moving range are calculated to obtain moving trajectories,
the outer ring is configured so that the lever is provided at the position of the temporary lever associated with the trajectory satisfying a condition that the square of a correlation coefficient between variables which are the positional coordinate values is 0.9 or more, and
the compression spring is provided on the trajectory in a direction identical to a direction of the trajectory, and makes contact with the lever.

12. The variable capacity-type gear pump designing method according to claim 6, wherein
when the linearity index value is within the predetermined range of linearity index values, a direction of an approximated straight line between variables which are the coordinate values is used as a direction of the compression spring.
